(19) United States
(12) Patent Application Publication
(10) Pub. No.: US 2019/0054384 A1
(43) Pub. Date: Feb. 21, 2019

(54) Toy Gun

(71) Applicant: Alex Brands Buzz Bee Toys (HK) Limited, Kowloon (HK)

(72) Inventor: Brownie Johnson, Brooklyn, NY (US)

(21) Appl. No.: 15/681,486

(22) Filed: Aug. 21, 2017

(51) Int. Cl. A63H 5/00; A63H 33/00; A63H 33/26; H04R 1/02; H04R 3/00; H04R 1/10

(52) U.S. Cl. CPC A63H 5/00; A63H 33/009; A63H 33/26; H04R 1/028; H04W 4/10; H04R 1/1016; A63H 2200/00; H04R 2420/07; H04R 2499/11; H04R 3/00

(57) ABSTRACT

The invention relates to a toy gun. The toy gun comprises a microphone module for receiving an incoming sound signal and converting said incoming sound signal to an outgoing audio signal, and a speaker module for receiving an incoming audio signal and converting said incoming audio signal to an outgoing sound signal; the microphone module and the speaker module being electronically connected with a processing module for processing the incoming and outgoing audio signals; and a communications module for communicating the audio signals between the toy gun and one or more other toy guns or portable audio devices distant to the toy gun; wherein the microphone module and the speaker module are positioned at or near a rear end of the toy gun, such that a user is able to hold and operate the toy gun whilst being able to operate the microphone module without a need to substantially reposition a hand of the user holding the toy gun.

### FIELD OF THE INVENTION

The invention relates to a toy gun and, particularly, but not exclusively, to a toy gun provided with communication functionalities.

### BACKGROUND OF THE INVENTION

A variety of toy guns are available in the market. Particularly, toy guns have been designed with both decorative and functional features in order to mimic the appearance, operation as well as a user's experience of real guns. For example, audio features have been incorporated into toy guns to simulate the sound effects of real guns. Various electronic components have also been incorporated into traditional toy guns aiming to enhance the user's experience.

### OBJECTS OF THE INVENTION

An object of the present invention is to provide a toy gun with a communication functionality.

Another object of the present invention is to provide a novel positioning of a sound receiver and a sound transmitter of a toy gun to thereby enhance experience of the user during play.

A further object of the present invention is to mitigate or obviate to some degree one or more problems associated with known toy guns, or at least to provide a useful alternative.

The above objects are met by the combination of features of the main claim; the sub-claims disclose further advantageous embodiments of the invention.

One skilled in the art will derive from the following description other objects of the invention. Therefore, the foregoing statements of object are not exhaustive and serve merely to illustrate some of the many objects of the present invention.

### SUMMARY OF THE INVENTION

In a first main aspect, the invention provides a toy gun comprising a microphone module for receiving an incoming sound signal and converting said incoming sound signal to an outgoing audio signal, and a speaker module for receiving an incoming audio signal and converting said incoming audio signal to an outgoing sound signal; the microphone module and the speaker module being electronically connected with a processing module for processing the incoming and outgoing audio signals; and a communications module for communicating the audio signals between the toy gun and one or more functional units distant to the toy gun; wherein the microphone module and the speaker module are positioned at or near a rear end of the toy gun, such that a user is able to hold and operate the toy gun whilst being able to operate the microphone module without a need to substantially reposition a hand of the user holding the toy gun.

In a second main aspect, the invention provides a toy gun system. The toy gun system comprises a first toy gun having a microphone module for receiving an incoming sound signal and converting said incoming sound signal to an outgoing audio signal, and a speaker module for receiving an incoming audio signal and converting said incoming audio signal to an outgoing sound signal; the microphone module and the speaker module being electronically connected with a processing module for processing the incoming and outgoing audio signals; and a communications module for communicating the audio signals between the first toy gun and one or more second toy guns. The toy gun system further comprises a portable audio device distant from the first toy gun and is wearable by a user of the first toy gun, the portable audio device being connectable with the first toy gun via one or more of a wireless connection and an electronic connection, such that one or more of the speaker module and the microphone module are adapted to be automatically disabled when the portable audio device is connected with the first toy gun.

In a third main aspect, the invention provides a method of manufacturing a toy gun. The method comprises the steps of providing a microphone module and a speaker module at or near a rear, handle portion of the toy gun, such that the user is able to hold and operate the toy gun whilst being able to operate the microphone module without a need to substantially reposition a hand of the user holding the toy gun.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figure, of which:

FIG. 1 is a side, external view of a toy gun according to an embodiment of the present invention;

FIG. 2 is a top view of the toy gun of FIG. 1;

FIG. 3 is a side, internal view of the toy gun of FIG. 1; and

FIG. 4 is a top view of the toy gun of FIG. 1 showing the internal features of the rear, handle portion of the toy gun.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

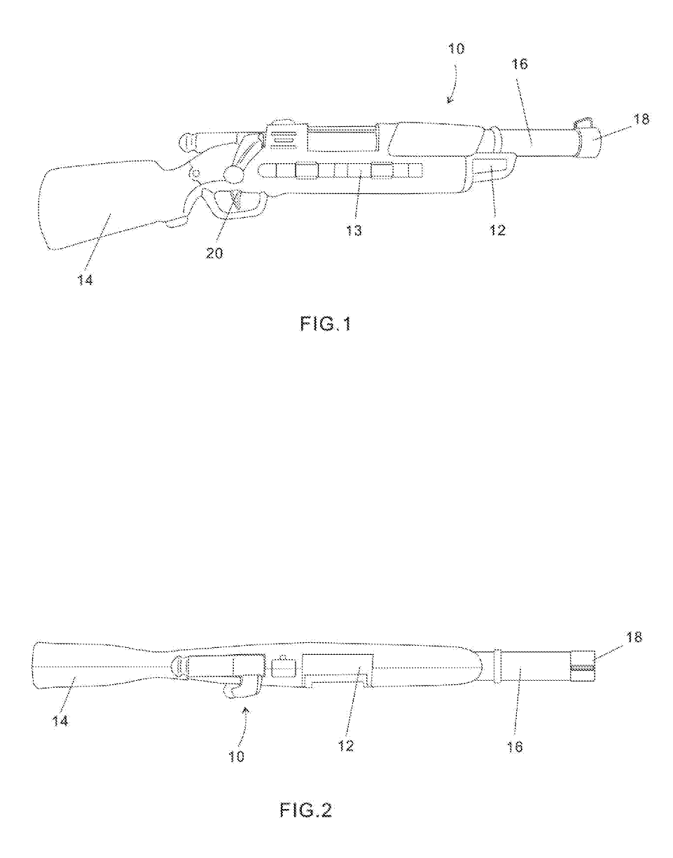

Referring to FIGS. 1 and 2, shown is a toy gun 10 according to an embodiment of the present invention. The toy gun 10, which is designed to mimic a rifle toy gun in this embodiment, is generally configured with a gun body 12 having an enlarged handle 14 at its rear end, a barrel 16 extending at least partially along the length of the gun body 12, a muzzle 18 arranged at the end of the barrel 16, and a trigger 20 for triggering launching of a projectile such as a dart or bullet from the barrel 16. During play, a user may carry the toy gun 10 by holding the handle 14 with one hand, and the elongated central portion 13 of the gun body 12 at the other hand to thereby stabilize position of the toy gun 10. Particularly, the user may position the enlarged handle 14 at or adjacent his or her upper body during shooting so as to allow additional support to the toy gun 10 to thereby assist and improve accuracy of the shot.

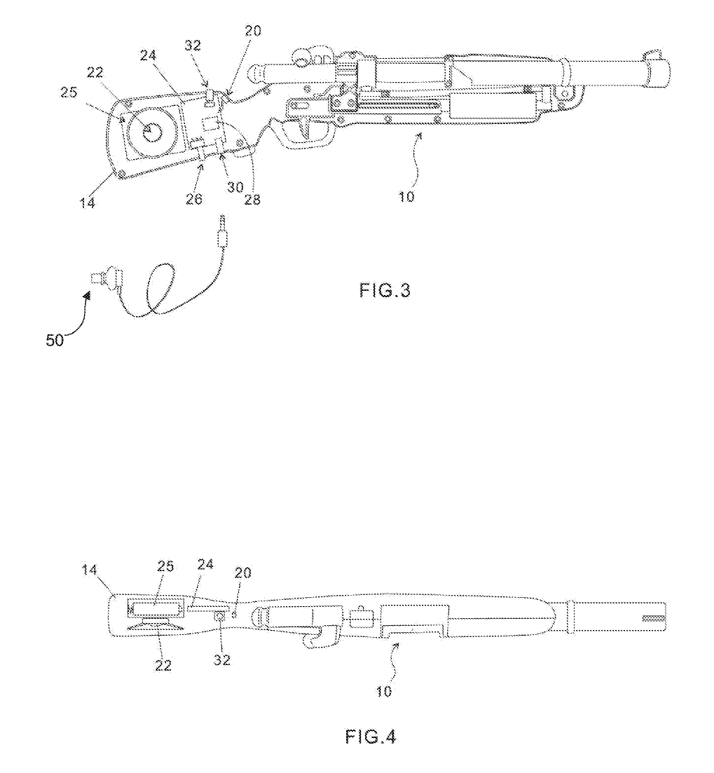

FIGS. 3 and 4 further show the internal structures of the toy gun 10. In this embodiment, the toy gun 10 comprises a microphone module 20 and a speaker module 22. The microphone module 20 is adapted to receive an incoming sound signal, for example, a voice signal from a user. The microphone module 20 is further adapted to convert said incoming sound signal to an outgoing audio signal. The speaker module 22 is adapted to receive an incoming audio signal, for example, a signal received from one or more external functional units distant from the toy gun 10, such as but not limited to, one or more electronic devices or toy units equipped with the relevant audio and/or electronic components. The speaker module 22 is then adapted to convert said incoming audio signal to an outgoing sound signal.

The microphone module 20 and the speaker module 22 can be electronically connected with a processing module 24, such as a printed circuit board (PCB) 24 for processing the incoming and outgoing audio signals. The microphone module 20, the speaker module 22, and the processing module 24 can be powered by any suitable power source, such as a battery 25, and be actuated by a power switch 26, as shown in the figures.

Preferably, the toy gun 10 may further comprise a communications module 28 adapted to communicate the audio signals between the toy gun 10 and the functional units distant to the toy gun 10. In one embodiment, the communications module 28 may comprise a radio frequency module adapted to communicate the audio signals via radio frequency. The functional units may comprise one or more other toy guns wirelessly communicable with the toy gun 10 via, for example, radio frequency. The other toy guns can be of an identical configuration or of a different configuration to that of the toy gun 10, as long as the other toy guns are capable of wirelessly communicating audio signals with the toy gun 10. Additionally or alternatively, the functional units may also comprise one or more portable audio devices 50, and preferably, wearable audio devices 50 such as but not limited to, headphones, earphones or the like. These wearable audio devices 50 can be arranged to wirelessly connect with the toy gun 10, such as but not limited to, via radio frequency; and/or to electronically connect with the toy gun 10, such as by using an electric cable which connects the wearable audio devices 50 with the toy gun 10 via the earphone jack 30 of the toy gun 10, as shown in the figures.

Particularly, the microphone module 20 and the speaker module 22 are preferred to be provided at the enlarged handle 14 positioned at or near the rear end of the toy gun 10, such that the user, during play, is able to hold and operate the toy gun 10, such as positioning and aiming the toy gun 10, whilst being able to operate the microphone module 20, such as by speaking at the microphone module 20 at a sufficiently short distance to thereby allow the voice signal to be detectable and receivable by the microphone module 20, without a need to substantially reposition a hand of the user holding the toy gun.

In one embodiment, the microphone module 20 may comprise at least one microphone, and the speaker module 22 may comprise at least one speaker, which can be one or more of a loud speaker, a headphone and an earphone. In one further embodiment, the microphone module 20 and the speaker module 22 are configured in the form of a combined, transceiver device such as one being used in a traditional walkie-talkie device to allow a more compact configuration.

During play, a first player operating the toy gun 10, herein referred to as the first toy gun 10 for clarity, is able to hold and position the toy gun 10 with its handle 14 support at or placed adjacent to his head or shoulder to thereby assist with aiming and positioning of the toy gun 10. With the microphone module 20 being provided at the rear handle 14, the first player is able to talk to one or more other players, for example, a second player operating a second toy gun, via the microphone module 20. A voice signal of the first player can be readily detected and received by the receiver of the microphone module 20 due to the proximate positioning of the microphone module 20 relative to the player. The microphone module 20, after receiving the voice signal as a sound signal, will convert the sound signal into an outgoing audio signal processable by the processing module 24. The processed outgoing audio signal will then be transmitted by the communications module 28 of the toy gun 10 to a corresponding communications component of the second toy gun.

Depending on the specific audio features and configurations of the second toy gun, the transmitted processed audio signal from the first toy gun will be received, processed, and converted into a sound signal audible by the second player at the second toy gun. To respond to the first player, the second player may speak at the microphone of the second toy gun and a voice signal will be received and processed, and a corresponding audio signal will be transmitted to the first toy gun 10.

The audio signal from the second toy gun, which is now an incoming audio signal to the first toy gun 10, will be received by the communications module 28, processed by the processing module 24, and be converted and emitted by the speaker module 22 into a sound signal audible by the first player. Alternatively, the incoming audio signal may also be received, processed, and emitted from a portable audio device 50 such as an earphone wearable by the first player. Preferably, one or more of the microphone module 20 and the speaker module 22 of the toy gun 10 are adapted to be automatically disabled when the portable audio device 50 is connected with and is detected by the toy gun 10. For example, the speaker module 22 at the toy gun 10 will be automatically turned off when it is detected that an earphone is connected to operate with the toy gun 10. This is advantageous in preventing any static noises produced from the toy gun from being audible in the play environment, such that location of the player will not be disclosed to the other players due to sound.

In one further embodiment, the microphone module 20 and the speaker module 22 operate on a mechanism similar to a traditional walkie-talkie device. Specifically, the toy gun 10 operates normally in a receiver mode, i.e. the speaker module 22 constantly receives signals from any other toy guns or audio devices operating on the same radio frequency, and outputs the received audio signals as sound signals to the first player. During this mode, the microphone module 20 is not operating and that the toy gun 10 is not emitting any radio frequency signals or audio signals. However, when the first player of the toy gun 10 wants to send a voice signal to one or more other players, he or she would have to push a microphone button 32 to enable it. Then the first player speaks into the microphone 20 whilst the button 32 is depressed, and a radio transmitter of the communications module 28 would be triggered to transmit the resulting audio signal on the wireless operating frequency. In one specific embodiment, it is preferred for the microphone button 32 be positioned at the top edge of the handle 14 of the toy gun 10, as shown in the figures, as it is where a player would generally place their right thumb, assuming for a right-handed user, when holding the toy gun 10. The positioning of the microphone button 32 thus allows a simple movement of the player's thumb to actuate the microphone button 32 when operating the toy gun 10. The press-to-talk basis of the microphone module 20 is beneficial because, if the microphone module 20 were allowed to be always on, it would unavoidably pick up any sound in the play environment and be constantly transmitting audio signals. The constant transmissions from all similar toy guns and devices would cause bad radio interference which prevents the one player from receiving proper incoming signals from the other players or toy guns.

In another aspect of the present invention, it is provided a toy gun system comprising a first toy gun 10 having a microphone module 20 for receiving an incoming sound signal and converting said incoming sound signal to an outgoing audio signal; and a speaker module 22 for receiving an incoming audio signal and converting said incoming audio signal to an outgoing sound signal. The microphone module 20 and the speaker module 22 being electronically connected with a processing module 24 adapted to process the incoming and outgoing audio signals. The first toy gun 10 further comprises a communications module 28 for communicating the audio signals between the first toy gun 10 and one or more second toy guns. The system further comprises a portable audio device 50, such as a headphone or earphone or the like being distant from the first toy gun 10 and is wearable by the user of the first toy gun 10. The portable audio device 50 is connectable with the first toy gun 10 via wireless connection, such as but not limited to radio frequency communication, and/or via electronic connection such as electric cable, such that one or more of the speaker module 22 and the microphone module 20 are adapted to be automatically disabled when the portable audio device 50 is connected with the first toy gun 10.

In yet a further aspect of the present invention, there is provided a method of manufacturing a toy gun 10. The method comprises the steps of providing a microphone module 20 and a speaker module 22 at or near a rear, handle portion 14 of the toy gun 10, such that during play, the user is able to hold and operate the toy gun 10 whilst being able to operate the microphone module 20, such as by speaking at the microphone of the microphone module 20 at a sufficiently short distance to thereby allow his voice signal to be detectable and receivable by the microphone module 20, without a need to substantially reposition a hand of the user holding the toy gun.

Although a toy gun configured to mimic a rifle gun having an enlarged rear handle has been described as specific embodiments, it is apparent that the present invention should not be limited to a toy rifle gun, but to encompass any other possible configurations of toy firearms or toy guns.

The present invention is advantageous in that it provides a toy gun or a toy gun system which allows a player to instantly communicate with one or more other players each having a similarly configured toy gun. The invention enables the players to play as a team, such as to mimic a war game setting, and to talk and respond with one another even if they are spread out and are at different locations. Particularly, the positioning of the microphone module and the speaker module at or near a rear, handle portion of the toy gun is beneficial in allowing the user to hold and operate the toy gun whilst being able to speak at the microphone at a sufficiently short distance, such that the voice signal can be detected and received by the microphone module, without a need to substantially reposition the hand of the player holding the toy gun. The use of an earphone in additional to or as an alternative to the speaker further assist in preventing any static noises from being audible in the play environment, such that location of the player will not be disclosed to the other players due to sound. The present invention thus significantly enhances the user's experience when playing the toy gun.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims hereof, any element expressed as a means for performing a specified function is intended to encompass any way of performing that function. The invention as defined by such claims resides in the fact that the functionalities provided by the various recited means are combined and brought together in the manner which the claims call for. It is thus regarded that any means that can provide those functionalities are equivalent to those shown herein.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art is referred to herein, such prior art does not constitute an admission that the prior art forms a part of the common general knowledge in the art.

1. A toy gun, comprising:
A toy gun body with a stock having a comb;
a microphone module for receiving an incoming sound signal and converting said incoming sound signal to an outgoing audio signal, and a speaker module for receiving an incoming audio signal and converting said incoming audio signal to an outgoing sound signal; the microphone module and the speaker module being electronically connected with a processing module for processing the incoming and outgoing audio signals, the microphone module located at a top front region of the comb; and
a communications module for communicating the audio signals between the toy gun and one or more functional units distant to the toy gun;
wherein the speaker module is positioned at or near a rear end of the toy gun, such that a user is able to hold and operate the toy gun whilst being able to operate the microphone module without a need to substantially reposition a hand of the user holding the toy gun.

2. The toy gun according to claim 1, wherein the one or more functional units comprise one or more other toy guns wirelessly communicable with the toy gun.

3. The toy gun according to claim 1, wherein the one or more functional units comprise one or more portable audio devices communicable with the toy gun via one or more of a wireless connection and an electronic connection.

4. The toy gun according to claim 3, wherein the one or more portable audio devices comprise wearable audio devices.

5. The toy gun according to claim 1, wherein the microphone module comprises at least one microphone, and the speaker module comprises at least one speaker.

6. The toy gun according to claim 5, wherein the at least one speaker comprises at least one of a loud speaker and an earphone.

7. The toy gun according to claim 1, wherein the speaker module is positioned at a rear, handle portion of the toy gun.

8. The toy gun according to claim 3, wherein one or more of the microphone module and the speaker module are adapted to be automatically disabled when the one or more portable audio devices are connected with the toy gun.

9. The toy gun according to claim 1, wherein the communications module comprises a radio frequency module adapted to communicate the audio signals via radio frequency technology.

10. The toy gun according to claim 1, wherein the microphone module and the speaker module are configured in the form of a combined, transceiver device.

11. The toy gun according to claim 1, wherein the toy gun body configured in the form of a rifle toy gun.

12. A toy gun system, comprising:
a first toy gun having a toy gun body with a stock having a comb, a microphone module for receiving an incoming sound signal and converting said incoming sound signal to an outgoing audio signal, and a speaker module for receiving an incoming audio signal and converting said incoming audio signal to an outgoing sound signal, the microphone module located at a top front region of the comb; the microphone module and the speaker module being electronically connected with a processing module for processing the incoming and outgoing audio signals; and a communications module for communicating the audio signals between the first toy gun and one or more second toy guns; and
a portable audio device distant from the first toy gun and is wearable by a user of the first toy gun, the portable audio device being connectable with the first toy gun via one or more of a wireless connection and an electronic connection, such that one or more of the speaker module and the microphone module are adapted to be automatically disabled when the portable audio device is connected with the first toy gun.

13. (canceled)

14. The toy gun according to claim 1, wherein the microphone module comprises a microphone button positioned at a top edge of the stock of the gun body.

15. The toy gun according to claim 1, wherein the speaker module comprises an earphone jack positioned at a bottom of the stock adjacent the comb.
